(19) United States
(12) Patent Application Publication
(10) Pub. No.: US 2009/0150513 A1
(43) Pub. Date: Jun. 11, 2009

(54) Method and System for Gathering Network Data

(75) Inventors: James Hilving, McKinney, TX (US); Traci Ann Fairchild, Thomaston, CT (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/953,217

(22) Filed: Dec. 10, 2007

(51) Int. Cl. G06F 15/16

(52) U.S. Cl. 709/217

(57) ABSTRACT

A system comprises a portal which, for each of a plurality of requests for network data from a plurality of parties, is to: determine which server of a plurality of servers is responsible for gathering data from a network element that has the network data being requested, send a data-gathering task to the server, receive the network data gathered from the network element by the server, and provide the network data to its requesting party.

### FIELD OF THE DISCLOSURE

The present disclosure is generally related to methods and systems for accessing network element data.

### BACKGROUND

Various systems, tools and individuals require access to a vast assortment of data associated with elements of a network. An example of this data is configuration data of a router. Gathering the network element data in real-time is made difficult task due to time constraints, accuracy, and network load.

### BRIEF DESCRIPTION OF THE DRAWINGS

FIG. 1 is a block diagram of an embodiment of a system for enabling multiple parties to access network element data;

FIG. 2 is a flow chart of an embodiment of a method performed by a portal of the system;

FIG. 3 is a flow chart of an embodiment of a method performed by an engine daemon run by a network element access server of the system;

FIG. 4 is a flow chart of an embodiment of a method of synchronization between the network element access servers and the portal; and

FIG. 5 is a block diagram of an illustrative embodiment of a general computer system.

### DETAILED DESCRIPTION OF THE DRAWINGS

Disclosed herein are embodiments of a network access funnel (NAF) that enable multiple parties to access and/or change network element data. Embodiments of the NAF funnel multiple requests from many sources to gather real-time network data from managed network elements (e.g. routers) of a network. Embodiments of the NAF assemble the real-time network data in an efficient, productive, and conscientious manner. Embodiments of the NAF can streamline a data gathering process that otherwise uses various network management portals and diverse access tools (whether they be from vendors, developed in-house, and/or open-source) to access network element data gathering functions. A network entity may embody the NAF using its existing network element access servers.

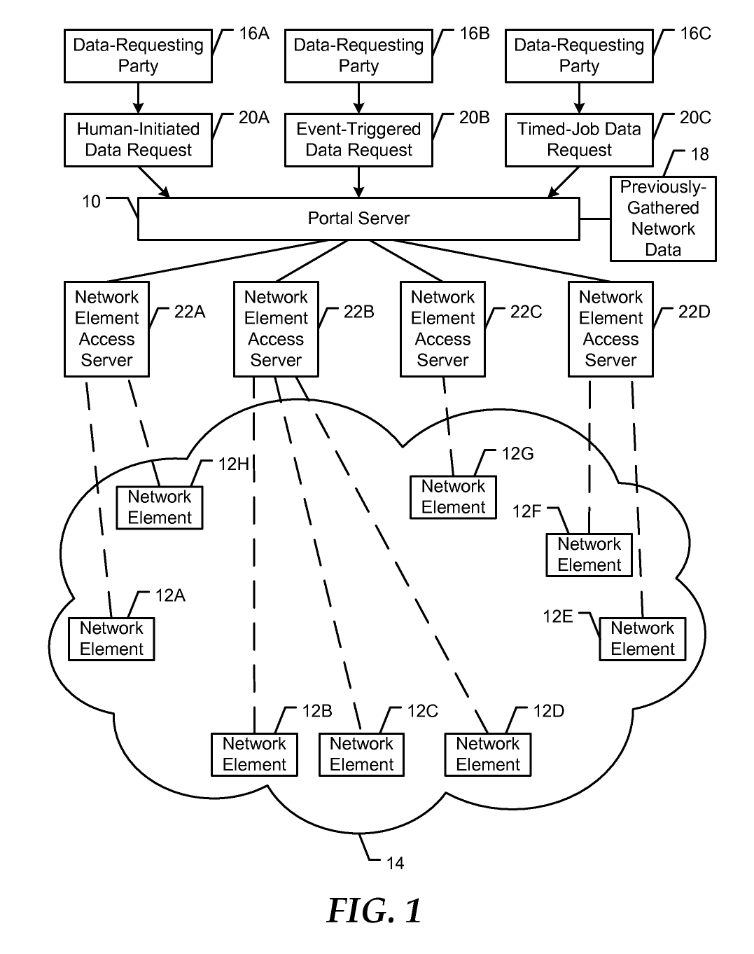

FIG. 1 is a block diagram of an embodiment of a system for enabling multiple parties to access network element data. The system comprises a portal server 10 that provides a consolidated, front door for regulating data gathering from network elements 12 of a network 14. Examples of the network elements 12 include, but are not limited to, routers and switches that are actively used to communicate data in the network 14. In some embodiments, the portal server 10 regulates data gathering from hundreds (e.g. 800 or more) of routers and switches in the network 14. A particular example of the network 14 is an AS7132 infrastructure that comprises AS7132 network devices.

The portal server 10 is accessed by a plurality of different data-requesting parties 16 who make network-data requests 20. Each of the network-data requests 20 is a request for network data from one or more of the network elements 12. Examples of network-data requests include, but are not limited to, requests to download router configurations and show commands.

For purposes of illustration and example, consider the data-requesting party 16A making the network-data request 20A to request network data from the network element 12A, the data-requesting party 16B thereafter making the network-data request 20B to request network data from the network element 12B, and the data-requesting party 16C thereafter making the network-data request 20C to request network data from the network element 12A.

The data-requesting parties 16 may initiate the network-data requests 20 in a variety of different ways. For purposes of illustration and example, consider the network-data request 20A being a human-initiated data request, the network-data request 20B being an event-triggered data request, and the network-data request 20C being a timed-job data request. Human-initiated data requests may be initiated via the Web and/or via a command line. Event-triggered data requests may be triggered by events such as a system log or a Simple Network Management Protocol (SNMP) trap, for example. Timed-job data requests may triggered by routine jobs that are executed after a timed interval.

The portal server 10 receives and processes the various network-data requests 20. For each network-data request, the portal server 10 determines whether or not an associated data gathering task is to be performed. The portal server 10 may determine that a particular data gathering task associated with a particular network-data request is to be inhibited because the network data being requested has been previously gathered and stored in a database 18, and the previously-gathered network data is acceptably presentable. In this case, the portal server 10 responds to the particular network-data request by providing the previously-gathered network data to the requesting party without accessing any of the network elements 12. Use of previously-gathered network data mitigates excessive usage of the network elements 12.

Those data gathering tasks that the portal server 10 do not inhibit are sent to one or more network element access servers 22. The network element access servers 22 are disposed at regionally diverse locations. In an embodiment, the system comprises four network element access servers at four geographically diverse locations.

The network element access servers 22 run engine daemons or alternative processes to receive and process the data gathering tasks. Based on the received tasks, the engine daemons attempt to aggressively gather data from the network elements 12 without excessively accessing any particular network element. In this way, the engine daemons gather data from the network elements 12 and send the gathered data back to the portal server 10 while preventing an internal DoS (Denial of Service) attack on any equipment in the network elements 12.

In an embodiment, the engine daemons prevent excessive access by preventing any of the network elements 12 from performing more than one data gathering task within a particular buffer time interval. This and other approaches may be used to limit how often respective data gathering tasks are forwarded to each of the network elements 12. For example, the engine daemons may delay gathering data from a particular network element until a time that is the particular buffer time interval after last gathering data from the particular network element. The particular buffer time may be configured by an administrator. In one embodiment, the particular buffer time is about 90 seconds. Another approach to preventing excessive access is for the engine daemons to limit a number of concurrent data-gathering requests submitted to each of the network elements 12.

The portal server 10 may distribute the data gathering tasks to the network element access servers 22 to dynamically balance loads of the engine daemons. Dynamically balancing the loads of the resources that directly access the network elements 12 mitigates challenges associated with equipment maintenance, equipment additions, and failures of mission critical access servers or hop boxes, to parties that require the network data.

The network element access servers 22 running the engine daemons receive the gathered data from the network elements 12 in response to the data-gathering requests submitted to the network elements 12. The engine daemons forward the gathered data back to the portal server 10 and/or the database 18 that consolidates gathered data. The portal server 10, in turn, provides particular gathered data to a particular one of the data-requesting parties 16 to fulfill its particular one of the network-data requests 20.

All the data gathered from the network 14 and consolidated back to a main location (e.g. the database 18) is mirrored to the network element access servers 20. Mirroring causes each of the network element access servers 20 to store all of the gathered data, including data that was gathered by others of the network element access servers 20 and services. Synchronizing gathered data between the portal server 10 and the network element access servers 20 promotes a unified appearance of the system.

Activity between the portal server 10 and the network element access servers 20 are monitored to provide through statistics on activity in/out of the network 14 via the system. Respective data may be stored and updated for each of the network elements 12. Examples of the respective data for a network element include, but are not limited to, a last time that the network element had a telnet communication, a last time that a configuration of the network element was checked, and a last time that a configuration of the network element was modified.

Continuing with the above example, consider the portal server 10 receiving the network-data request 20A to request network data from the network element 12A, and determining that a data gathering task is to be performed based thereon. The portal server 10, in turn, sends the data gathering task to the network element access server 22A. The network element access server 22A, in turn, determines that the network element 12A has not been excessively accessed and thus gathers the data from the network element 12A. The network element access server 22A forwards the gathered data to the portal server 10. The portal server 10 forwards the gathered data to the data-requesting party 16A to fulfill the network-data request 20A. The gathered data is stored by the database 18, and synchronized to the other network element access servers 22B, 22C and 22D.

Further continuing with the example, consider the portal server 10 receiving the network-data request 20B to request network data from the network element 12B, and determining that a data gathering task is not to be performed based thereon. The portal server 10, in turn, retrieves previously-gathered data (i.e. data gathered from the network element 12B before the network data request 20B was made) from the database 18. The portal server 10 forwards the previously-gathered data to the data-requesting party 16B to fulfill the network-data request 20B.

Still further continuing with the example, consider the portal server 10 receiving the network-data request 20C to request network data from the network element 12A, and determining that a data gathering task is to be performed based thereon. The portal server 10, in turn, sends the data gathering task to the network element access server 22A. The network element access server 22A, in turn, delays gathering data from the network element 12A until a time that is the particular buffer time interval after gathering data based on the network-data request 20A. After the particular buffer time interval has elapsed, the network element access server 22A gathers the data from the network element 12A. The network element access server 22A forwards the gathered data to the portal server 10. The portal server 10 forwards the gathered data to the data-requesting party 16C to fulfill the network-data request 20C. The gathered data is stored by the database 18, and synchronized to the other network element access servers 22B, 22C and 22D.

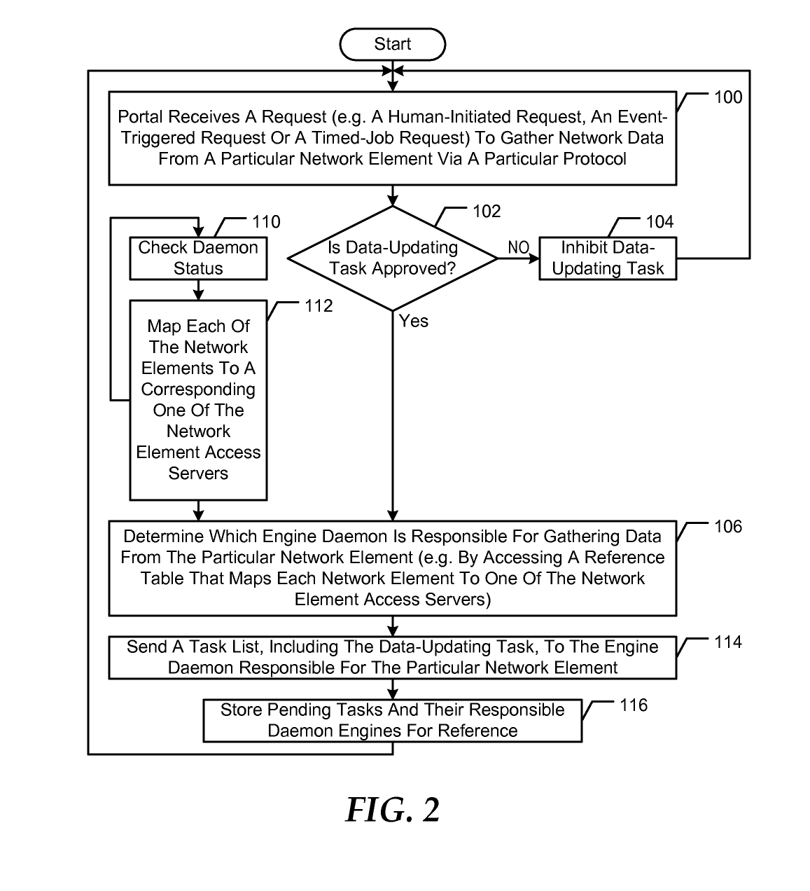

FIG. 2 is a flow chart of an embodiment of a method performed by the portal server 10. As indicated by block 100, the method comprises receiving a request to gather network data from a particular network element via a particular protocol. Examples of the particular protocol include, but are not limited to, Telnet, SNMP and Remote Shell (RSH). As previously described herein, the request may be human-initiated, event-triggered, or a timed-job.

As indicated by block 102, the method comprises determining if a data-updating task is approved, per requirements, to gather the requested network data.

If the data-updating task is not approved, then an act of inhibiting a data-updating task is performed as indicated by block 104. Inhibiting the data-updating task inhibits the particular network element from being accessed in response to the request. The act of inhibiting may comprise dropping the task to prevent excessive usage of the network. Previously-gathered data from the particular network element can be provided to a party that submitted the request in order to fulfill the request. An act of logging an event of dropping the task may be performed.

If the data-updating task is approved, then an act of determining which engine daemon/network element access server is responsible for gathering data from the particular network element is performed (as indicated by block 106). The responsible engine daemon/network element access server can be determined by accessing a reference table that maps each of the network elements 12 to one of the network element access servers 22.

The reference table may be generated by repeatedly checking the status of the various engine daemons, as indicated by block 110. For example, the status may be checked periodically (e.g. every 5 minutes or another period) and/or in response to a task failure for an engine daemon. Based on the status of the various engine daemons and network element access servers 22, each of the network elements 12 is mapped to a corresponding one of the network element access servers 22, as indicated by block 112. Thus, each of the network element access servers 22 is given a primary list of network elements for which it is responsible.

As previously described herein, the mapping can be performed dynamically in order to balance a load of the network element access servers 22. For purposes of illustration and example, and with reference to FIG. 1, consider the reference table mapping the network elements 12A and 12H to the network element access server 22A, mapping the network elements 12B, 12C and 12D to the network element access server 22B, mapping the network elements 12E and 12F to the network element access server 22D, and mapping the network element 12G to the network element access server 22C.

Referring back to FIG. 2, as indicated by block 114, the method comprises sending a task list, including the data-updating task, to the engine daemon responsible for the particular network element. As indicated by block 116, the method comprises storing pending tasks and their responsible engine daemons/network element access servers for future reference.

By performing the method of FIG. 2 for multiple requests, a respective task list is sent to each of the network element access servers 22 running the engine daemons for each data method. Each respective task list may comprise one or more respective data-gathering tasks.

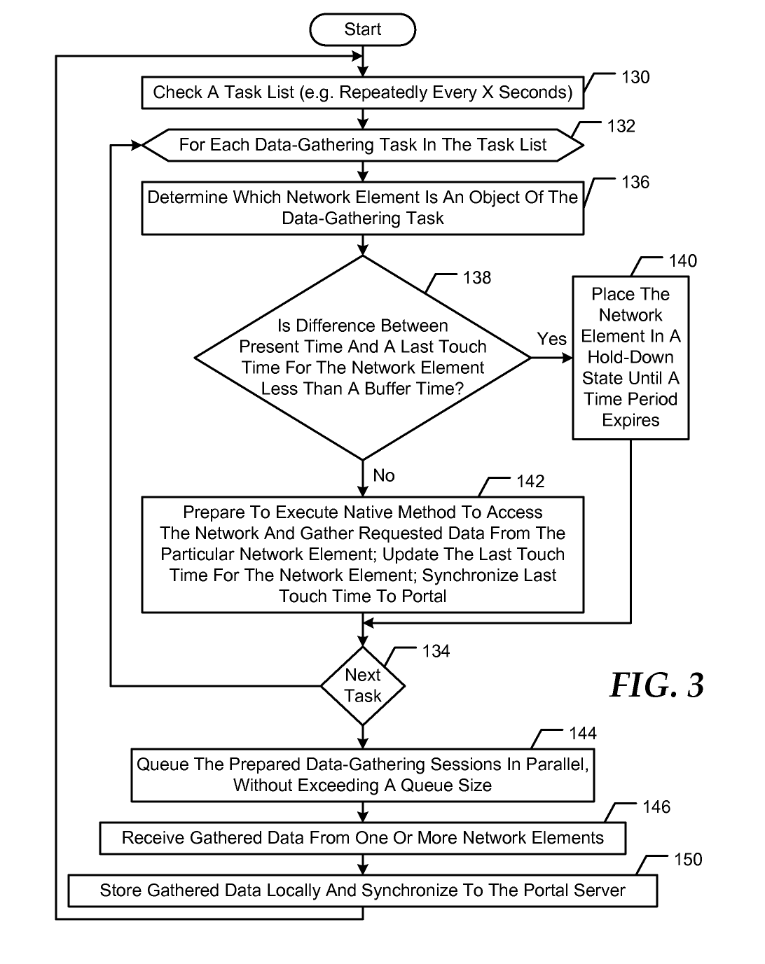

FIG. 3 is a flow chart of an embodiment of a method performed by an engine daemon run by a network element access server. The method is performed based on a task list received from the portal server 10.

As indicated by block 130, the method comprises repeatedly checking the task list. By repeatedly, it is meant that the task list may be checked either periodically or aperiodically. In an embodiment, the task list is checked periodically, for example every 3 seconds or another period.

As indicated by blocks 132 and 134, acts are performed for each data-gathering task in the task list. As indicated by block 136, an act of determining which network element is an object of the data-gathering task is performed. As indicated by block 138, the method comprises determining if a difference between a present time and a last-touch time for the network element is less than a buffer time interval. The last-touch time for the network element is a time that a most-recent data gathering task has been performed for the network element. This act can be performed based on a comparison involving values calculated based on the present time, the last-touch time for the network element, and the buffer time interval.

If the difference between the present time and the last-touch time for the network element is less than the buffer time interval, then the network element is placed in a hold-down state until a time period has expired (as indicated by block 140). The hold-down state ensures that the network element is not touched until the time period has expired. A default value of the time period is 90 seconds in an embodiment.

If the difference between the present time and the last-touch time for the network element is greater than or equal to the buffer time interval (and the network element is not otherwise in a hold-down state), then block 142 is performed. Block 142 comprises preparing to execute a native method to access the network 14 and gather requested data from the network element. Block 142 may further comprise updating the last-touch time for the network element based on the present time, and synchronizing the last-touch time with the portal server 10.

As indicated by block 144, the method comprises queuing, in parallel, one or more data-gathering sessions prepared in block 142. This act may comprise ensuring that a number of parallel data-gathering sessions in the queue never exceed a defined queue size. The parallel data-gathering sessions gather data from one or more network elements 12 via the network 14.

As indicated by block 146, the method comprises receiving gathered data from the one or more network elements. As indicated by block 150, the gathered data is stored locally by the network element access server and is synchronized to the portal server 10. The portal server 10, in turn, forwards respective gathered data back to each of the data-requesting parties (e.g. the data-requesting parties 16A and 16C) to fulfill their network data requests (e.g. the network data requests 20A and 20C).

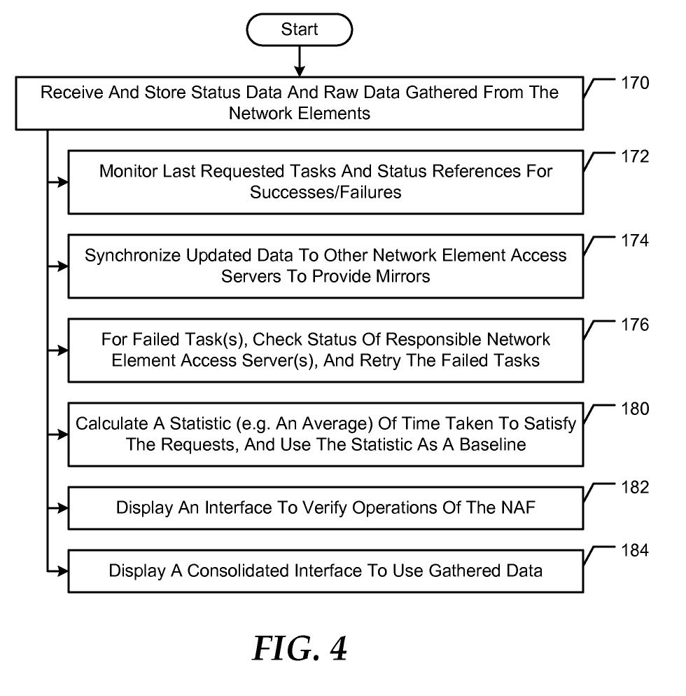

FIG. 4 is a flow chart of an embodiment of a method of synchronization between the network element access servers 22 and the portal server 10. As indicated by block 170, the method comprises the portal server 10 receiving and storing status data and updated data gathered from the network elements 12. The data can be stored in the database 18. A number of different acts can be performed based on the data, as described below.

As indicated by block 172, the NAF can monitor last-requested tasks and status references for successes and failures. As indicated by block 174, the updated data can be synchronized to other, and possibly all, network element access servers 22 to provide mirrors of the data. As indicated by block 176, for failed task request(s), a status of responsible network element access server(s) can be checked, and the failed task request(s) can be retried. As indicated by block 180, one or more statistics (e.g. an average) of a time taken to satisfy the requests can be calculated, and used as a baseline for comparison purposes. As indicated by block 182, an interface can be displayed to verify some, and possibly all, operations of the NAF. As indicated by block 184, a consolidated interface can be displayed so that gathered data can be used by requesting parties and other authorized parties. The consolidated interface presents the gathered data in a customizable interface that is accessible by all parties that need the data and are granted the permissions.

By streamlining all the required tasks that are to be performed based on data requests, embodiments of the NAF can increase productivity and efficiency of gathering data from the network elements 12. Embodiments of the NAF can be dynamically scaled to greater numbers of resources that run the network access engine daemons at physically diverse locations. Embodiments of the NAF may leverage already existing data gathering processes and may not require major reworks to the network 14 or to existing methods. The processes for gathering data, or engine daemons, can also be easily added as new network elements and methods for gathering data are required. Thus, embodiments may be transparent to existing setups.

If a task for a network element makes it through to the engine daemon, the engine daemon places the network element into a hold-down state which protects the network element by preventing any other tasks until a hold-down period has elapsed. After the hold-down period has elapsed, the engine daemon proceeds to gather the data from the network element.

Embodiments can be used to alleviate real-time router configuration gathering delays on a common backbone, which can currently take as long as 24-36 hours to update. Embodiments may be able to accomplish this need in less than 10 seconds after a change has been seen no more than once every 90 seconds to prevent overload. Embodiments can be used to take full network snapshot of router configuration data.

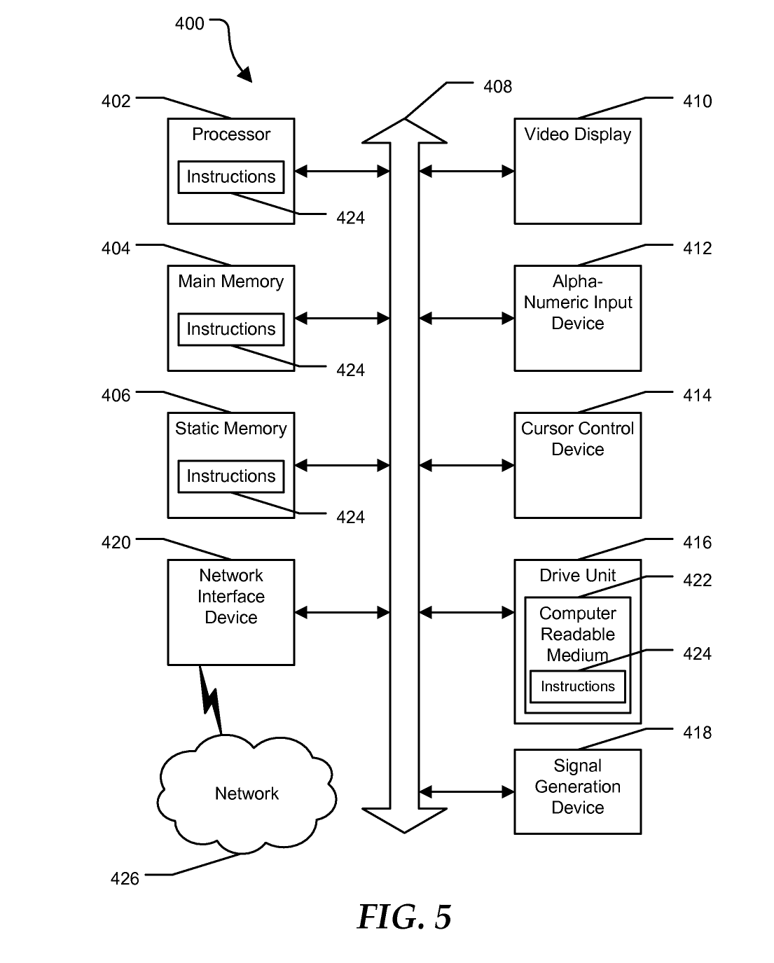

Referring to FIG. 5, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 5, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 5, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a portal which, for each of a plurality of requests for network data from a plurality of requesting parties, is to: determine which server of a plurality of servers is responsible for gathering data from a network element that has the network data being requested, send a data-gathering task to the server, receive the network data gathered from the network element by the server, and provide the network data to its requesting party.

2. The system of claim 1 wherein the plurality of requests comprise a plurality of requests for router configuration data of at least router.

3. The system of claim 1 wherein the portal, for at least one other request for network data, is to: inhibit a data-gathering task for gathering data from a network element that has the network data being requested, and provide previously-gathered network data to its requesting party, the previously-gathered network data gathered prior to the request.

4. The system of claim 1 wherein the plurality of requests comprise a human-initiated request, an event-triggered request, and a timed-job request.

5. The system of claim 1 wherein the portal is to map a plurality of network elements to the servers to indicate, for each of the network elements, which server is responsible for gathering data therefrom.

6. The system of claim 5 wherein the portal is to dynamically map the plurality of network elements to the servers to attempt to balance loads of data-gathering tasks performed by the servers.

7. The system of claim 5 wherein the portal is to dynamically map the plurality of network elements to the servers in response to detecting a failure of a data-gathering task.

8. The system of claim 1 wherein the portal is to synchronize the network data gathered from the network element by the server with all others of the servers.

9. The system of claim 1 wherein the server, in response to the data-gathering task, places the network element in a hold-down state based on determining that a difference between a present time and a last-touch time for the network element is less than a threshold, and thereafter gathers the network data from the network element after a hold-down time period has expired.

10. A method comprising:
receiving, by a portal, a plurality of requests for network data from a plurality of requesting parties; and
for each of the plurality of requests, using the portal to:
determine which server of a plurality of servers is responsible for gathering data from a network element that has the network data being requested;
send a data-gathering task to the server;
receive the network data gathered from the network element by the server; and
provide the network data to its requesting party.

11. The method of claim 10 wherein the plurality of requests comprise a plurality of requests for router configuration data of at least router.

12. The method of claim 10 further comprising:
for at least one other request for network data, using the portal to:
inhibit a data-gathering task for gathering data from a network element that has the network data being requested; and
provide previously-gathered network data to its requesting party, the previously-gathered network data gathered prior to the request.

13. The method of claim 10 wherein the plurality of requests comprise a human-initiated request, an event-triggered request, and a timed-job request.

14. The method of claim 10 further comprising:
mapping a plurality of network elements to the servers to indicate, for each of the network elements, which server is responsible for gathering data therefrom.

15. The method of claim 14 wherein said mapping comprises dynamically mapping the plurality of network elements to the servers to attempt to balance loads of data-gathering tasks performed by the servers.

16. The method of claim 14 wherein said mapping comprises dynamically mapping the plurality of network elements to the servers in response to detecting a failure of a data-gathering task.

17. The method of claim 10 further comprising:
synchronizing the network data gathered from the network element by the server with all others of the servers.

18. The method of claim 10 further comprising:
in response to the data-gathering task, placing the network element in a hold-down state based on determining that a difference between a present time and a last-touch time for the network element is less than a threshold; and
gathering the network data from the network element after a hold-down time period has expired.

19. A computer-readable storage medium encoded with a computer program, the computer program to cause a computer system to:
provide a portal to receive a plurality of requests for network data from a plurality of requesting parties; and
for each of the plurality of requests, to:
determine which server of a plurality of servers is responsible for gathering data from a network element that has the network data being requested;
send a data-gathering task to the server;
receive the network data gathered from the network element by the server; and
provide the network data to its requesting party.

20. The computer-readable storage medium of claim 19 wherein the plurality of requests comprise a plurality of requests for router configuration data of at least router.

21. The computer-readable storage medium of claim 19 wherein the computer program is to cause the computer system, for at least one other request for network data, to:
inhibit a data-gathering task for gathering data from a network element that has the network data being requested; and
provide previously-gathered network data to its requesting party, the previously-gathered network data gathered prior to the request.

22. The computer-readable storage medium of claim 19 wherein the computer program is to cause the computer system to perform an act of:
mapping a plurality of network elements to the servers to indicate, for each of the network elements, which server is responsible for gathering data therefrom.

23. The computer-readable storage medium of claim 22 wherein said mapping comprises dynamically mapping the plurality of network elements to the servers to attempt to balance loads of data-gathering tasks performed by the servers.

24. The computer-readable storage medium of claim 22 wherein said mapping comprises dynamically mapping the plurality of network elements to the servers in response to detecting a failure of a data-gathering task.

25. The computer-readable storage medium of claim 19 wherein the computer program is to cause the computer system to:
synchronize the network data gathered from the network element by the server with all others of the servers.
